(19) United States
(12) Patent Application Publication
(10) Pub. No.: US 2006/0064446 A1
(43) Pub. Date: Mar. 23, 2006

(54) Calculator with error notification function and its method

(75) Inventors: Chih-Cheng Chien, Shenkeng Township (TW); You-Shiv Li, Shenkeng Township (TW)

Correspondence Address: BACON & THOMAS, PLLC, 625 SLATERS LANE, FOURTH FLOOR, ALEXANDRIA, VA, 22314, US

(73) Assignee: Kinpo Electronices, Inc., Taipei (TW)

(21) Appl. No.: 11/009,075

(22) Filed: Dec. 13, 2004

(30) Foreign Application Priority Data
Sep. 17, 2004 (TW) 093128330

(51) Int. Cl. G06F 15/00

(52) U.S. Cl. 708/200

(57) ABSTRACT

A calculator with error notification function and its method are disclosed. At first, an equation is inputted into the calculator and temporarily stored, wherein the equation is composed of multiple operational units. Next, a comparison is applied between the equation and multiple operational rules in order to find and tag at least one error in the equation. Finally, the equation would be displayed in company with an error marked in the displayed equation according to the tagged error.

### BACKGROUND OF THE INVENTION

1. Field of the Invention

The present invention relates to an electronic computing product, and more particularly, to a calculator with error notification function and its method.

2. Description of Related Art

Currently, with the development of electronic technology, calculators are gradually used in place of manual calculation with paper and pens. A calculator provides not only basic operations including addition, subtraction, multiplication and division, but also more complex operations, such as trigonometric function operations and high-level operations. Users can rapidly obtain either the result of a simple equation or the result of a complex high-level equation via the computing function of calculators.

However, when using the calculator, an “error” message may usually occur if unacceptable values exist in the equation, and the equation may be automatically eliminated in company with the error message. For example, using “0” as a divisor, using improper parameters in a function, or an overflow caused by exceeding digits of the operation result always leads to the error message. According to the error message, the user only knows there's an error in the whole operation procedure without realizing exactly where the error is in the entered equation. Thus, the user cannot learn from the error message, and it's inconvenient for the user to re-enter the equation for re-calculating the result.

Therefore, it is desirable to provide an improved calculator with error notification function and its method to mitigate and/or obviate the aforementioned problems.

### SUMMARY OF THE INVENTION

The object of the present invention is to provide a calculator with error notification function and its method, which avoids shutdown of the calculator and inconvenience of re-entering the equation for users when an error message occurs.

To achieve the object, the calculator with error notification function of the present invention includes an input unit, a storage unit, a rule unit, a display unit, and a processing unit. The input unit is used for inputting an equation composed of a plurality of operational units. The storage unit is used for storing the equation. The rule unit is used for storing a plurality of operational rules causing operational errors. The display unit is used for displaying the equation and its result. The processing unit is used for executing the equation. The processing unit is characterized in that it compares the equation with the operational rules stored in the rule unit to find and tag at least one error in the equation before executing the equation, and marks the error in the displayed equation according to the tagged error.

According to another aspect of the present invention, an operational method applied in the above-mentioned calculator with error notification function comprises the steps of: inputting an equation composed of a plurality of operational units; temporarily storing the equation; comparing the equation with a plurality of operational rules for finding at least one error in the temporarily stored equation; tagging the error in the equation; and displaying the equation and marking the error in the displayed equation according to the tagged error.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of the calculator capable of error notification according to the present invention;

FIG. 2 is a control flowchart of the calculator capable of error notification according to the present invention;

FIG. 3 is an exemplary drawing of an aspect of the embodiment according to the present invention; and

FIG. 4 is an exemplary drawing of another aspect of the embodiment according to the present invention.

### DETAILED DESCRIPTION OF THE PREFERRED EMBODIMENT

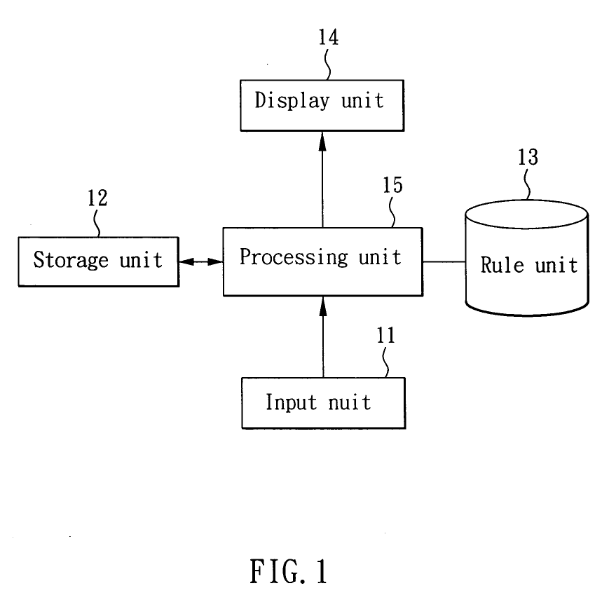

Please refer to FIG. 1. FIG. 1 is a block diagram of a calculator with error notification function in accordance with an embodiment of the present invention. The calculator includes an input unit 11, a storage unit 12, a rule unit 13, a display unit 14, and a processing unit 15. A user inputs data or commands into the calculator through the input unit 11 in order to control the calculator or to perform an operation. For example, an equation can be inputted through the input unit 11 and then executed by the processing unit 15. Please note that the aforementioned equation is composed of multiple operational units, including operators, operands, functions, and parameters. The aforesaid storage unit 12 is used for storing control programs of the calculator, and it is also used for temporarily storing the inputted equation, values produced in the operation procedure, and the result of the equation. The aforesaid display unit 14 is used for displaying data outputted by the calculator, such as the inputted equation and its result.

The abovementioned rule unit 13 stores multiple operational rules each causes an operational error. For example, the operational rules include: [Rule 1] Using zero as a divisor: ‘/0’ exists in an equation; [Rule 2] Using asymmetrical parentheses: the number of left parentheses ‘(’ differs from the number of right parentheses ‘)’ in an equation; and [Rule 3] Using improper functional parameters: the functional parameter is not computable for the function, for example, in the function ‘sin(45+A)’, ‘A’ is a variable, not a value. According to these operational rules provided by the rule unit 13, a comparison can be applied between the equation and each operational rule in order to find at least one error in the equation and notify the user.

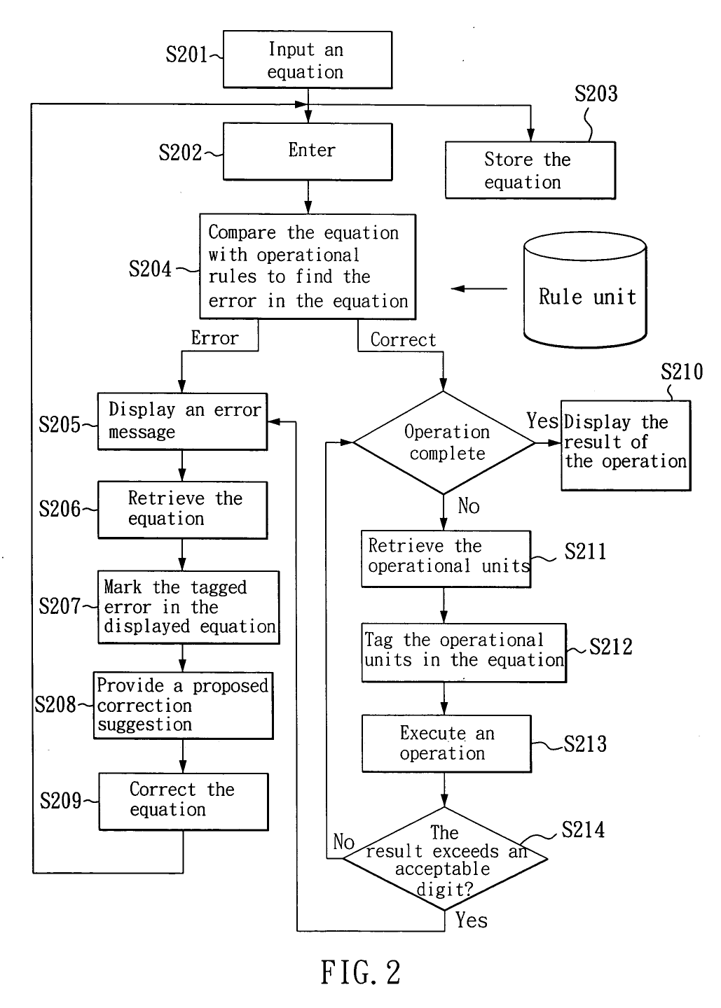

With reference to FIG. 2, there is shown a control flowchart of the aforesaid calculator with error notification function according to the embodiment of the invention. At first, the user inputs an equation through the input unit 11 (S201). Next, the user presses the ‘Enter’ key to input the equation into the calculator (S202). This inputted equation is temporarily stored in the storage unit 12 (S203).

In step S204, the processing unit 15 compares the equation with each operational rule stored in the rule unit 13 in order to find the error in the equation, and then tags the error in the equation temporarily stored in the storage unit 12. If the inputted equation does have an error, the processing unit 15 displays an error message in the display unit 14 (S205), then retrieves the temporarily stored equation from the storage unit 12 (S206), and marks the error in the displayed equation according to the tagged error (S207). Therefore, the user could realize where causes the error in the whole equation. In addition, the processing unit 15 is further capable of providing a proposed revision opinion according to the operational rules stored in the rule unit 13 (S208). Hence the user could be able to correct the equation through the input unit 11 according to the proposed correction suggestion (S209), and press the ‘Enter’ key to re-execute the equation after finishing correcting the equation.

On the other hand, in step S204, if the comparison between the equation and the operational rules in the rule unit 13 assures that the equation is correctly inputted, the processing unit 15 could start to execute the equation. The processing unit 15 retrieves at least one target operational unit, which may include an operand, an operator, a function, or a parameter, from the equation (S211) for performing an operation. At the same time, the processing unit 15 tags the target operational units in the equation temporarily stored in the storage unit 12 (S212), and then performs an operation to the target operational units (S213). In this embodiment, if the result of the equation exceeds an acceptable digit of the processing unit 15 (S214), steps S205 to S209 would be executed thereby. That is, the processing unit 15 displays an error message in the display unit 14 (S205), then retrieves the temporarily stored equation from the storage unit 12 (S206), and marks a location in the displayed equation that causes an overflow according to the tagged operational unit (S207). Further, the processing unit 15 provides a proposed correction suggestion (S209) for the user to correct the equation through the input unit 11 (S209). After inputting the corrected equation, the ‘Enter’ key is pressed by the user in order to re-execute the equation and therefore repeat the aforesaid operational steps.

Please refer to step S214 again, if the result of the equation doesn't exceed the acceptable digit of the processing unit 15, steps S211 to S213 would be repeatedly executed until the whole operation is completed and the result is displayed on the display unit 14.

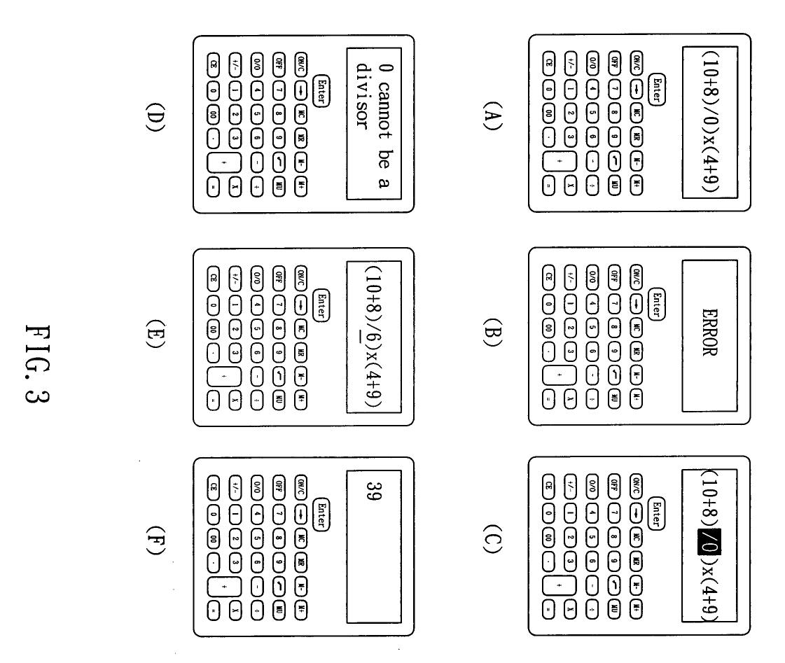

Please refer to FIG. 3. FIG. 3 is an exemplary drawing of an aspect of the embodiment according to the present invention. In this embodiment, the user inputs the equation: ((10+8)/0)×(4+9) (FIG. 3A). After the user presses the ‘Enter’ key, the processing unit 15 compares the equation with each operational rule stored in the rule unit 13, and finds an error of having a ‘/0’ in the equation. Therefore, the processing unit 15 tags the error in the equation, and displays an ‘ERROR’ message in the display unit 14(FIG. 3B). The processing unit 15 marks the error in the displayed equation by highlighting or twinkling the error according to the tagged error (FIG. 3C). Further, the processing unit 15 provides a proposed correction suggestion (FIG. 3D) for the user to correct the equation through the input unit 11 (FIG. 3E). After finishing correcting the equation, the user presses the ‘Enter’ key to re-execute the equation for obtaining a correct result (FIG. 3F).

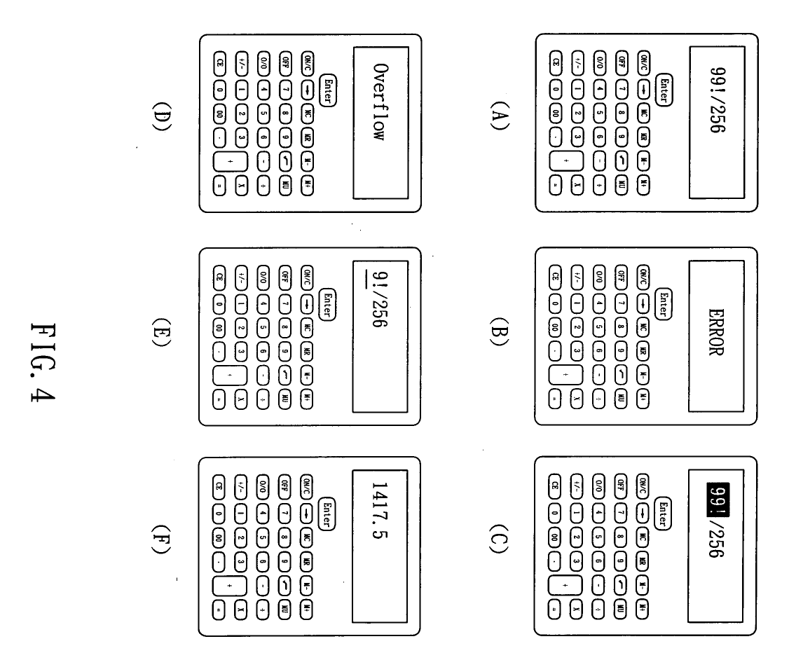

Reference is made to FIG. 4. FIG. 4 is an exemplary drawing of another aspect of the embodiment according to the present invention. In this embodiment, the user inputs the equation: 99!/256 (FIG. 4A). After the user presses the ‘Enter’ key, the processing unit 15 compares the equation with each operational rule stored in the rule unit 13, and finds the equation is correctly inputted. Therefore, the processing unit 15 starts to execute the equation. The processing unit 15 firstly retrieves target operational units ‘99’ and ‘!’ from the equation and tags these target operational units. Next, the processing unit 15 executes an operation to ‘99!’. Because the result of the operation exceeds an acceptable digit of the processing unit 15, an ‘ERROR’ message is displayed in the display unit 14 (FIG. 4B). The processing unit 15 then highlights or twinkles ‘99!’ according to the tagged operational units (FIG. 4C). Further, the processing unit 15 provides a proposed correction suggestion (FIG. 4D) for the user to correct the equation through the input unit 11 (FIG. 4E). After finishing correcting the equation, the user presses the ‘Enter’ key to re-execute the equation for obtaining a correct result (FIG. 4F).

Although the present invention has been explained in relation to its preferred embodiment, it is to be understood that many other possible modifications and variations can be made without departing from the spirit and scope of the invention as hereinafter claimed.

What is claimed is:

1. A calculator with error notification function, comprising:
an input unit for inputting an equation composed of a plurality of operational units;
a storage unit for storing the equation;
a rule unit for storing a plurality of operational rules causing operational errors;
a display unit for displaying the equation and its result; and
a processing unit for executing the equation;
wherein the processing unit compares the equation with the operational rules stored in the rule unit to find and tag at least one error in the equation before executing the equation, and marks the error in the displayed equation according to the tagged operational error.

2. The calculator as claimed in claim 1, wherein the processing unit further provides a proposed correction suggestion according to the operational rules stored in the rule unit.

3. The calculator as claimed in claim 1, wherein when executing the equation, the processing unit retrieves and tags at least one operational unit from the equation, and executes an operation to the at least one operational unit, so as to mark a location of an overflow in the displayed equation according to the tagged operational unit when the operation results in a value exceeding an acceptable digit.

4. The calculator as claimed in claim 3, wherein the operational unit comprises operands, operators, functions, and parameters.

5. The calculator as claimed in claim 1, wherein the operational rules causing errors comprise: using zero as a divisor, using asymmetrical parentheses, and using improper parameters in a function.

6. An operational method of a calculator with error notification function, comprising the steps of:
(A) inputting an equation composed of a plurality of operational units;
(B) temporarily storing the equation;
(C) comparing the equation with a plurality of operational rules for finding at least one error in the equation;
(D) tagging the error in the temporarily stored equation; and
(E) displaying the equation and marking the error in the displayed equation according to the tagged error.

7. The operational method as claimed in claim 6, further comprising the step of:
(F) providing a proposed correction suggestion according to the operational rules.

8. The operational method as claimed in claim 6, wherein if step (C) finds no errors in the equation and assures an accuracy of the equation, the method further comprises the steps of:
(G) retrieving at least one operational unit from the equation;
(H) tagging at least one operational unit in the temporarily stored equation; and
(I) executing an operation to the at least one operational unit, wherein the at least one operational unit is marked in the displayed equation if the operation results in a value exceeding an acceptable digit.

9. The operational method as claimed in claim 8, wherein the operational unit comprises operands, operators, functions, and parameters.

10. The operational method as claimed in claim 6, wherein in step (C), the operational rules causing errors comprise: using zero as a divisor, using asymmetrical parentheses, and using improper parameters in a function.
